(19) United States
(12) Patent Application Publication
(10) Pub. No.: US 2010/0079280 A1
(43) Pub. Date: Apr. 1, 2010

(54) Advanced object detector

(75) Inventors: Alberto Daniel Lacaze, Germantown, MD (US); Karl Nicholas Murphy, Rockville, MD (US)

Correspondence Address: Timothy John Van Tuinen, LLC, P.O.Box 351043, Toledo, OH, 43635, US

(73) Assignee: Robotic Research, LLC, Gaithersburg, MD (US)

(21) Appl. No.: 12/286,706

(22) Filed: Oct. 1, 2008

(51) Int. Cl. G08B 21/00

(52) U.S. Cl. 340/540; 340/686.6; 340/825.36

(57) ABSTRACT

An advanced object detector, system and method comprising a memory device which contains a library of tailor-made signals and specific object resonances with those signals; an antenna which will act as both the exciter and receiver directing the memory device's tailor-made signals towards locations potentially having the objects intended to be detected and receiving resonated signals from said objects being detected which have resonated with said tailor-made signals; said memory device may then interpret and categorize the resonated signal by comparing the resonated signal with the library of specific objects and their resonance's with specific tailor-made signals. After identification and categorization the memory device may then respond to the presence of the object, alert another memory device for interaction or allow for human interaction through outputting the object's presence on a screen or alerting the human through some other means. In a preferred embodiment, the system can be handheld, mobile or static and can be made with a device that can provide a wide frequency response at frequencies likely to resonate with the weapons intended to be detected. It is to be understood that this invention may detect numerous objects, including but not limited to, piping, conductive, semi-conductive and non-conductive material that have the ability to resonate with specific tailor-made signals.

### BACKGROUND OF THE INVENTION

1. Field of the Invention

Detecting the presence of a sniper is an important capability for law enforcement agencies, military armed forces and the private sector (for example, private security firms). Increasingly, there is a need to detect the presence of harmful situations before any injuries or damage has occurred.

The present invention relates to apparatuses, systems and methods for remotely detecting weapons that are pointed towards a particular target. In particular, the invention relates to a prior-to-discharge warning system for use in the detection of weaponry such as rifles, shotguns, pistols and the like. However, other embodiments of the present invention will be apparent from the following specification and drawings, including the detection, inspection and cataloging of other tubular objects such as piping or any other objects made with a conductive, semi-conductive or non-conductive material or cavity.

2. Description of the Prior Art

It is a fact that U.S. Marines, Army ground forces, U.S. military Special Forces, police officers, government employees, civilians and other groups are constantly being targeted in conflict areas around the world, including Iraq. Urban settings provide a countless number of concealed positions for effective sniping and without proper notice of the presence of a sniper a target may be injured or killed.

Currently, there are no known weapon detection systems on the market that utilize the weapon's resonance with tailor-made signals to detect a sniper or marksman when he or she is in the state of preparing to fire a weapon. Most devices in operation detect the acoustics of the weapon being fired, detect the body signature of the sniper, detect the optics of the scope attached to the weapon, detect the metal in the weapon or detect the muzzle blast from the gun fire. Most of these apparatuses and methods are not useful in the detection of a sniper before a shot has been fired.

Acoustic sensors are used to localize a sniper's location through the identification of the acoustics that are emitted from the gunfire. As described in U.S. Pat. No. 5,930,202, a distributed array of acoustic sensors is used to detect the arrival times, amplitudes and frequency characteristics of a projectile's shockwave and the muzzle blast from a firearm. Consequently, this is only effective, if at all, only after a shot has been fired and the target has been killed or injured. Realistically, after a shot is fired, a target is already well aware of the sniper threat, so this reduces the acoustic sensor's applicability to the current needs of the armed forces.

Another method of detection currently in use consist of detecting the body signature of a sniper using various infrared and thermal imaging apparatuses. However, these methods of detecting snipers are extremely difficult to accomplish, especially since one of the main skills of a sniper is concealment. Even if these systems could detect one's body signature, their ability to properly categorize between enemy combatants from non-combatants is highly unlikely.

Other attempts at overcoming the disadvantage of detecting a sniper aiming a weapon have been made, however, some have flaws that allow for the use of a weapon without detection. For instance, scope detection can be performed since the optics and coatings present on a weapon's scope have characteristics that can be differentiated from the background. This detection method, however, is completely ineffective for rifles without scopes. Another attempt at overcoming the disadvantage of detecting a sniper holding a weapon has been to utilize radar to detect metal in the weapon. Unfortunately, this alternative will also give radar returns with other metallic structures and clutter in the urban setting.

Accordingly, there is a need for a weapons detector for use in the early warning and detection of specific objects, specifically, weapons being aimed at targets. There is also a need for an early warning system in which an accurate categorization, directionality and location of the specific weapon being used by the enemy combatant can be obtained.

The present invention solves the deficiencies of the prior art by allowing tailor-made signals to resonate within specific gun barrels which enables the system to properly categorize the weapon being detected and also determine its location and directionality. It is to be understood, however, that this invention is not limited to the detection of weaponry alone. This invention can also detect and categorize other objects which have specific resonances with tailor-made signals.

### BRIEF SUMMARY OF THE INVENTION

The present invention provides an advanced warning detection system for use in the detection of objects. More specifically, a preferred embodiment of the present invention provides a weapons detection system for use in the early warning and detection of weapons. The preferred weapons detector comprises: a memory device which contains a library of tailor-made signals and specific object resonances with said tailor-made signals; a means for radiating said tailor-made signals towards the object of interest; and a means for collecting said object of interest's resonated signal.

One preferred embodiment provides an advanced warning system, apparatus and method for use in the early warning, detection and categorization of weapons being aimed at targets by enemy combatants. This preferred embodiment will minimize the hazard to troops and civilians who are engaged in warlike situations. The preferred embodiment uses a memory device to send and receive tailor-made signals through an antenna or other signal emitting device. These tailor-made signals will resonate with specific objects, such as the barrel cavity of a gun or weapon. Once the tailor-made signals are encountered by the weapon being detected, the weapon's barrel cavity will either resonate with the tailor-made signals or it will not. Should the weapon resonate with the tailor-made signals, a resonated signal will then be returned to the antenna where it will be communicated to the memory device. The memory device may then interpret the weapon's resonance, or lack thereof, and allow for proper categorization of the weapon. This categorization is completed by using the weapon's specific resonance with specific tailor-made signals. The memory device contains a library of specific tailor-made signals and a library of specific resonated signals to those tailor-made signals depending on the weapon or object being detected. Categorization of the weapon, the weapon's locality and directionality are accomplished by the memory device comparing the weapon's resonated signal to a library of specific object resonances with tailor-made signals contained within the memory device. Once the weapon has been categorized, the memory device may then alert an individual, another computer or other device of the weapon's location and directionality in which a reaction to the presence of said weapon may then take place.

Through the use of tailor-made signals, the preferred embodiment allows for objects, such as weaponry, to resonate with specific tailor-made signals adapted to detect specific objects. This occurs when the tailor-made signals resonate within the body of the object intended to be detected. For instance, the barrel cavity of a specific type of gun or weapon will have a specific resonance with specific tailor-made signals. In accordance with the invention, an antenna will emit tailor-made signals which will resonate within the barrel cavity of a weapon, in which the barrel cavity itself will act as an effective clutter filter. This resonated signal, once returned to said antenna and memory device, can be properly categorized as a weapon or other object based on the resonated signal which is returned. Different barrel diameters and objects will provide different resonated signatures in the frequency domain, therefore allowing one to distinguish the particular object or weapon being detected and its aimed directionality and location. A library of commonly used weapons and other objects may be used to detect and perform filtering.

More specifically, the advanced warning system of the preferred embodiment will have a memory device and an antenna, which will send and receive waves, which can be tailor-made to distinguish various articles from one another. This distinction between the objects being detected is accomplished by comparing a specific object's resonance with tailor-made waves to a library of specific object resonances with said tailor-made waves.

Detection of weaponry is based on the inside of a gun or weapon barrel where modification or neglect will render the gun inoperable. However, effective snipers and marksmen strive to make sure that the barrel is clean and clear of debris to increase the effectiveness of the shot, therefore allowing for proper detection through the weapon's resonance with tailor-made signals.

In a preferred embodiment, the advanced warning system is made with a small antenna that can provide a wide frequency response at the frequencies likely to resonate with the weapons or other items intended to be detected. Alternatively, it can be made with other devices capable of emitting and receiving a signal and may be made up of one, many or an array of antennas.

One advantage of the advanced warning system of the preferred embodiment of the present invention includes the advanced warning and detection of weapons. Particularly, detection may be accomplished with any weapon or object that provides a resonance when encountered by tailor-made signals. Even if a weapon being detected is modified by the shortening of the barrel or by adding attachments, detection and categorization can still be performed by the system. This is possible because the detection of the weapon is based on the geometry of the weapon intended to be detected. For instance, the cavity of a gun barrel will resonate with emitted tailor-made signals from the antenna and will return a resonated signal back to the antenna allowing for the memory device to properly categorize the object as a weapon and determine its caliber, location and directionality based on the resonated signal that is returned.

Another advantage of a preferred embodiment of the present invention is the ability to categorize the weapon. Meaning, one can determine the caliber of a weapon through the weapon's resonance when encountered with specific tailor-made signals. Different barrel diameters provide different signatures in the frequency domain, therefore allowing one to distinguish the caliber of the weapon being detected based on the distinguishable signature provided when a weapon comes in contact with a tailor-made signal.

An additional advantage of the preferred embodiment of the present invention is the ability to determine the location and directionality of a weapon being detected through identifying the weapon's specific resonance with tailor-made signals. Depending on the direction in which the weapon is being aimed, specific tailor-made signals will resonate differently within the weapon's cavity. This is also true of determining the weapon's location in relation to the weapons detector system. Another advantage of a preferred embodiment of the present invention is the low amount of power the system utilizes in detecting weapons and objects. By not detecting metal itself but only detecting the cavity resonance of the object being detected, the system overall will use less energy when compared to other object detectors. This benefit allows dismounted armed forces to use a lower number of batteries when engaged in an activity, which also allows for the carrying of less overall weight.

The weapons detector and advanced warning system of a preferred embodiment of the present invention may be used by the armed forces, police, F.B.I., security officers, civilians and other organizations that require the detection of weaponry or objects. The preferred embodiments of the present invention include models for attachment to vehicles, for personal use, and attachment to buildings or other units in which the device will increase portability and/or tactical effectiveness. The preferred embodiments may also be used in the robotics field, including attachment to autonomous robotics and the like.

The preferred embodiment can indicate the presence of snipers and marksmen through an affirmative signal. Said affirmative signal may be: audible signals, silent signals, tactile signals, visual signals, mechanical signals, and displayed messages. The detector is useful for detecting weaponry such as rifles, shotguns, handguns or any other weapon or object that has the capability to resonate with tailor-made signals.

An additional embodiment of the present invention includes a system, apparatus and method for the detection and inspection of pipes in which tailor-made signals resonate within said pipe intended to be located or inspected. Through the use of tailor-made signals, which are stored in a memory device and emitted by an antenna, this embodiment allows for tailor-made signals to distinguish, categorize, locate and inspect various pipe products. Once said tailor-made signals come into contact with the pipe being located or inspected, said tailor-made signals will resonate within the pipe, returning a resonated signal to said antenna. Depending on the physical state and location of the pipe, said resonated signal will vary in the frequency domain, therefore allowing for proper categorization and a proper determination of the physical state of the pipe. Categorization of the physical state and a determination of the location of the pipe are accomplished through comparing said resonated signal to a library of objects and their specific resonances with said tailor-made signals.

It is an advantage of the present embodiment to determine the location and physical state of the piping being detected. Due to various variables such as time, weathering and wear and tear, piping and the like diminishes in its capacity to fulfill the job it was intended. In other words, piping erodes, cracks, or simply deteriorates over time. An object of the present embodiment is to allow for inspection of such piping through the use of tailor-made signals. When tailor-made signals come into contact with the piping being detected or inspected, a resonated signal is returned to an antenna which enables the memory device to compare said resonated signal to a library of specific object resonances with said tailor-made signals. Depending on the location and physical state of the piping being detected, specific tailor-made signals will resonate differently within the piping, allowing for specific resonated signals to be returned to said antenna. These distinguishable differences in the resonated signals allow for proper categorization of the piping and a determination of its location and physical state.

It is to be understood that the present embodiment of the current invention may be contained in a handheld unit or it may be mounted on a building, vehicle or other unit. The present embodiment may also be mounted on a robot for use autonomously or otherwise. The present embodiment may also be used to determine other characteristics of piping which have the capability of producing resonated signals.

It should be noted that the preferred embodiments described may use other frequency emitting devices which have the capability of emitting signals. It should also be noted that the present invention has the ability to detect objects other than weaponry and piping, including but not limited to, objects which are made of conductive, semi-conductive or non-conductive materials.

Although the detection system is shown and described herein as having a specific shape, it could have other shapes, as desired. For instance, the detection system could be oblong or have an ovoid shape, or it could be square, circular, octagonal, hexagonal, rectangular or have any other shape. It could also be housed in other materials or embodiments than those described, or not be housed at all.

It is to be noted that the above summary is simplified in nature and is not an extensive overview of the present invention, therefore, it should not be limiting in nature. Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The forgoing as well as other objects and advantages of the invention will become apparent from the following detailed description when considered in conjunction with the accompanying drawings and other material, wherein like reference characters designate like parts throughout the several views, and wherein:

FIG. 1.—is an isometric view of one of the preferred embodiments which may be attached to a vehicle, robot or other unit to provide maximum transportability and/or tactical effectiveness.

FIG. 2.—is a schematic of the preferred embodiment.

FIG. 3—indicates the reflectivity parameters of an AK47 as compared to the reflectivity parameters if no gun were present.

### DETAILED DESCRIPTION OF THE PREFERRED EMBODIMENT

It should be noted that the terms “tailor-made signal,” “resonated signal” and “memory device” shall be defined as follows and used in the following manner throughout the specification, claims and other referenced material. Tailor-made signals are defined as, but not limited to, signals that are specifically designed for a particular use, such as to resonate with specific objects by creating a resonance with said object. Resonated signals are defined as, but not limited to, signals that are produced by another signal, stimulus or vibration of certain amplitude interacting with an object which then creates a specific signature in the frequency domain as compared to the signal, stimulus or vibration the object has interacted with. Memory device is defined, but not limited to, a computer, processing means or other device which can store and produce information, such as tailor-made signals, and which can categorize collected resonated signals by comparing the received resonated signals to a library of specific object resonances with said tailor-made signals.

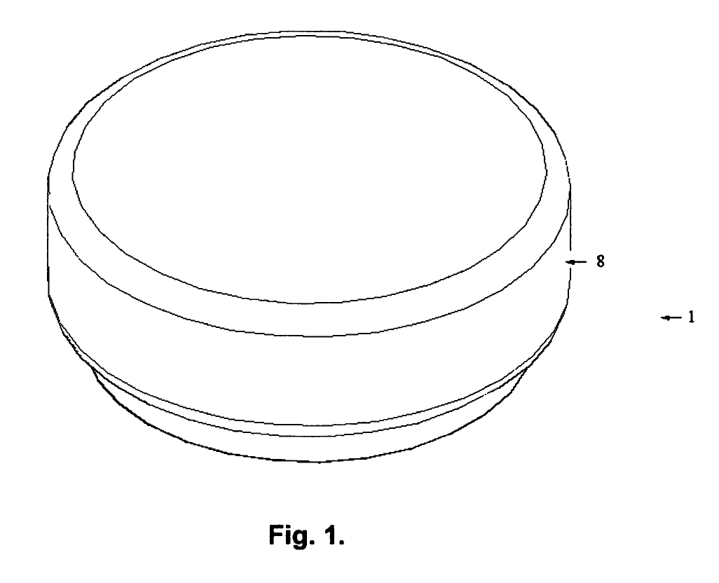

FIG. 1, represents the preferred embodiment, having a general reference numeral of 1. This embodiment may be attached to a vehicle, robot building or other unit. The preferred embodiment indicates a casing 8 in which the memory device and antenna have been housed. In the preferred embodiment, the system is small and versatile. It is made of durable materials and protected by a casing 8. It may also be protected in other manners and materials or not be protected at all. It may also be large and made of any material which can perform said operations properly. Said memory device and antenna may be housed in other cases or protective measures, and may be housed in the same or separate enclosures. An output means, not pictured, may also be house with said memory device and antenna, or may be housed separately.

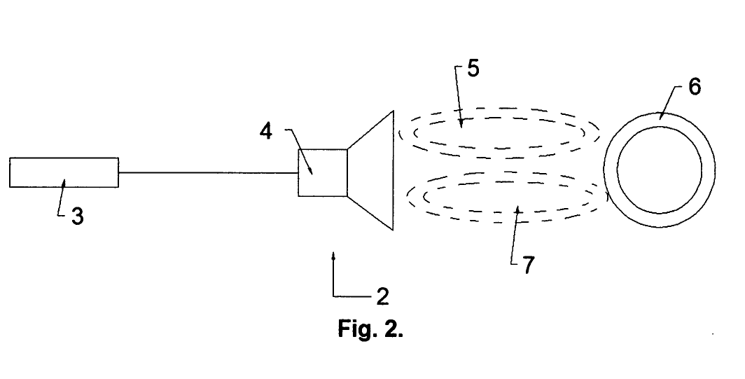

FIG. 2. represents a schematic of the preferred embodiment, represented generally at 2, which includes a memory device 3 for storing and generating tailor-made signals for transmission though an antenna 4. The memory device 3 has a library of specific tailor-made signals and specific object resonances with those tailor-made signals. The tailor-made signals are shown as dashed rings 5 emanating from the antenna 4. The tailor-made signals 5 emanated from the antenna 4 will resonate with the object being detected 6. After the tailor-made signals 5 have been in contact with the object being detected 6 a resonated signal 7, shown as dashed rings returning to the antenna 4, will be returned from the object being detected 6and reflected back as a resonated signal 7. The returned resonated signal 7 is transmitted to said memory device 3 to allow for categorization of the resonated signal 7. Categorization is performed by the memory device 3 through comparing said resonated signal 7 to a library of specific object resonances with said tailor-made signals 5 contained in the memory device 3 that correspond to specific objects.

Each object being detected 6 will allow for a resonance with a specific tailor-made signal 5. It is the change in the signal 5 sent through the antenna 4 to the object being detected 6 which allows for a resonated signal 7 to be categorized by the memory device 3 to determine what the object is being detected.

The memory device 3 includes a library of tailor-made signals 5 corresponding to individual objects. The memory device 3 also contains a library of resonated signals 7 which will correspond to specific objects and their resonance with specific tailor-made signals 5. For instance, handheld weapons, rifles, and other objects that allow for tailor-made signals 5 to resonate within their barrel cavities will provide distinct corresponding resonated signals 7 which can be properly categorized as a specific weapon or object.

The antenna 4 should allow for a wide frequency response at the frequencies likely to resonate with the objects being detected 6, such as gun barrels or other weapons. Rectangular arrays and linear arrays are available options for completing this task, however, other devices which can emit or receive signals or waves would also be acceptable.

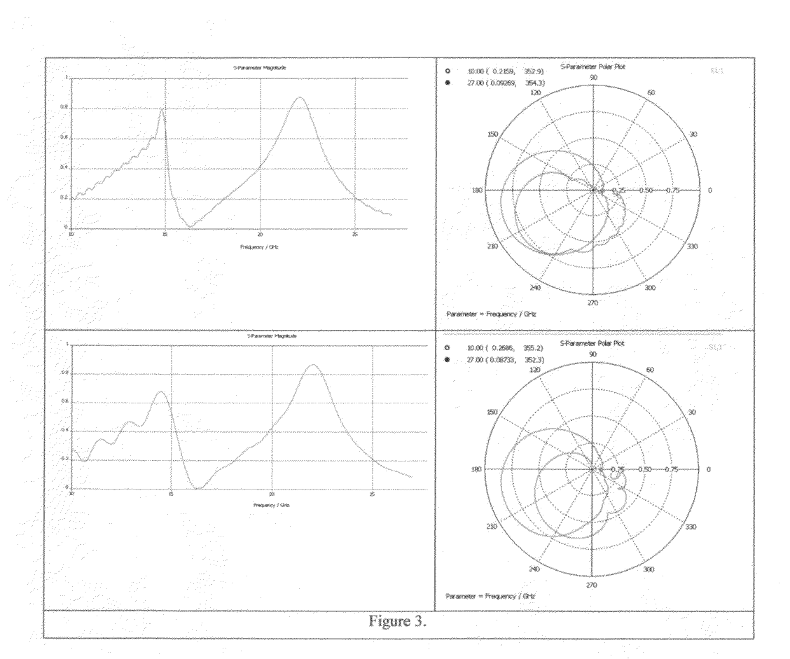

FIG. 3. represents the responses the antenna 4 will receive when the system is used to determine the presence of an AK47 using tailor-made signals 3. A 7.62 mm AK47 assault rifle barrel capped with a bullet was placed and aimed at the antenna in this simulation from a distance of 100 m. FIG. 3. indicates the reflectivity parameters for the two types of situations: with and without a gun barrel. The top two diagrams show the readings with a gun barrel and the bottom two diagrams show the readings when there is no gun barrel.

In the preferred embodiment the apparatus may be handheld and may be utilized by an individual or other unit. The preferred embodiment may also be attached to a vehicle, building, robot, autonomous robot or other unit to allow for maximum protection and/or versatility.

Although particular embodiments of the invention are illustrated and described in detail herein, it is to be understood that various changes and modifications may be made to the invention without departing from the spirit and intent of the invention as defined by the scope of the appended claims.

We claim:

1. An object detector comprising:
a memory device which contains a library of tailor-made signals and specific object resonances with said tailor-made signals;
a means for radiating said tailor-made signals towards an object of interest; and
a means for collecting said object of interest's resonated signal.

2. The detector in claim 1 in which the memory device can determine the specific object being located by categorizing the object's resonated signal through a comparison of the object's resonated signal to said library of specific object resonances with said tailor-made signals.

3. The detector in claim 1 in which at least one antenna will act as both the exciter and receiver of said tailor-made signals and said object's resonated signal to said tailor-made signals.

4. The detector in claim 1 in which more than one antenna, or an array of antennas will act as both the exciter and receiver of said tailor-made signals and said object's resonated signal to said tailor-made signals.

5. The detector of claim 2 further comprising an automatic affirmative signal if an appropriate mach is made between the received resonated signal and the library of object resonances with said tailor-made signals contained within said memory device.

6. The detector of claim 1 wherein said memory device receiving said resonated signals can output information on a screen.

7. The detector of claim 5 wherein said affirmative signal comprises at least one signal selected from the group consisting of audible signals, silent signals, tactile signals, visual signals, mechanical signals, and displayed messages.

8. The detector of claim 2 in which the detector has the ability to respond to the detection of said object.

9. The detector of claim 2 in which the detector can determine the objects location and directionality.

10. The detector of claim 2 in which the detector is a self-contained, hand-held detector.

11. The detector of claim 2 in which the detector in mounted on a vehicle, building or other unit.

12. The detector of claim 2 in which the detector is mounted on a robot for autonomous use.

13. The detector in claim 1 wherein the antenna is a rotating linear array or a rectangular array.

14. A method for detecting an object, said method comprising the steps of:
a) transmitting a tailor-made signal toward an object of interest;
b) said object of interest resonating with said tailor-made signal;
c) collecting a resonated signal that is reflected from the object of interest which has resonated with said tailor-made signal; and
d) categorizing said object based on the object's resonance with said tailor-made signals through comparing said resonated signal to a library of specific object resonances with said tailor-made signals.

15. The method in claim 14 additionally comprising an automatic affirmative signal if the object's resonated signal is properly matched within a library of object's resonances with said tailor-made signals.

16. The method in claim 14 additionally comprising the step of determining the approximate location of the object of interest through the specific resonance of said object being detected and its corresponding match in said library of object resonances with said tailor-made signals.

17. The method in claim 14 additionally comprising the step of determining the approximate directionality of the object being detected through the object's specific resonance with said tailor-made signals.

18. The method in claim 14 additionally comprising the step of determining the specific object being located.

19. The method of claim 14 wherein the step of transmitting, collecting and categorizing said object takes place in a self-contained, hand-held detector.

20. The method of claim 14 wherein the step of transmitting, collecting and categorizing said object takes place in a unit that is mounted on a vehicle, robot, building or other unit.

21. The method in claim 14 additionally comprising the step of reacting to said object's presence via autonomous robotics, human interaction or some other means of interaction.

22. The method in claim 15 wherein the step of generating a signal comprises generating at least one signal selected from the group consisting of audible signals, silent signals, tactile signals, visual signals, mechanical signals, and displayed messages.

23. An object detector system, comprising:
a. means for storing tailor-made signals and specific object resonances to said tailor-made signals;
b. means for emitting and receiving signals;
c. means for comparing specific object resonances with tailor-made signals to received signals; and
d. means for outputting information.
